(19) United States
(12) Patent Application Publication
(10) Pub. No.: US 2011/0019007 A1
(43) Pub. Date: Jan. 27, 2011

(54) Method, apparatus and method for adding functionality to a digital camera

(76) Inventors: Gidon Elazar, Cohav Yair (IL); Dan Harkabi, Moshav Lakis (IL); Ittai Rais, Ramat Hasharon (IL)

Correspondence Address: FOLEY AND LARDNER LLP;SUITE 500, 3000 K STREET NW, WASHINGTON, DC, 20007, US

(21) Appl. No.: 12/656,845

(22) Filed: Feb. 17, 2010

Related U.S. Application Data
(60) Provisional application No. 12/806,196, filed on Feb. 18, 2009.

(51) Int. Cl. H04N 5/225

(52) U.S. Cl. 348/207.1; 348/E05.024

(57) ABSTRACT

Extension of digital camera functionality through the use of an active digital media storage device is disclosed. Extended functionality included the ability to process images, send and receive digital content to and from a remote server, emulate user input mechanisms such as menus and textual input, send and receive email, SMS and other messages, and receive and display advertisements from a remote server. In some instances, features of Active Storage Device may be implemented directly in a Digital Camera.

### CROSS REFERENCE TO RELATED APPLICATIONS

This application claims the benefit of provisional patent Ser. No. 61/030,848 filed Feb. 22, 2008 by the present inventors.

This application claims the benefit of provisional patent Ser. No. 61/030,858 filed Feb. 22, 2008 by the present inventors.

This application claims the benefit of provisional patent Ser. No. 61/030,870 filed Feb. 22, 2008 by the present inventors.

This application claims the benefit of provisional patent Ser. No. 61/030,885 filed Feb. 22, 2008 by the present inventors.

### FIELD OF THE INVENTION

The present invention pertains to the fields of digital cameras, digital media storage cards, and digital content. More particularly, the invention pertains to expanding the functionality of digital media devices, using an active digital media storage device as a medium to create, access and process various digital content.

### BACKGROUND OF THE INVENTION

A Digital Still Camera (DSC) is a consumer electronics device that captures photos and records them in digital format. The photos are stored on removable media such as flash memory cards. The DSC industry is well established and many millions of cameras are sold yearly to consumers. DSC functionality exists in other consumer electronic devices such as video cameras, mobile phones, and PDAs. For the purpose of this invention, and due to the similarity of the photo capturing function among such devices, all of them shall be referred to as “DSC”.

Many of the modern DSCs use a removable storage card, and in many cases a flash memory card (herein “Memory Card”), as the data storage means for captured photos. The classic distribution of tasks between the DSC and the memory card is that the card is responsible to handle the retention of the data, mainly photos captured by the DSC, while a processor within the DSC is responsible for data manipulation, including capturing photos, processing photos as well as the decision of when and were to store this data. In this configuration the data card will be referenced as “Passive” or “Passive Memory Card”. Passive memory card activities include its ability to store and retrieve data flowing from or to a DSC or any other computational device that can be coupled with a memory card, for example a personal computer.

Technology developments in recent years have added to the functionality of DSC, and to their utility for consumers. For example, some models of DSC can interface with a GPS device and record together with each photo, an exact geographic location. Some DSC are being designed to include GPS functionality internally.

Currently, most DSC models require tethering to an external computer in order to transfer photos and data from the camera to the computer. Alternatively, the Memory Card may be removed from the DSC and connected to a computer. New DSC models will most likely include wireless functionality, for example the ability to communicate wirelessly with an 802.11 WiFi hotspot in order to transfer data from the Memory Card to a computer or server. This feature, for example, will allow a DSC to record a large number of images, unconstrained by the storage capacity of the removable memory card, because photos will be transferred and stored on a remote server automatically.

There is currently no feasible way for millions older DSC models in use by consumers to achieve this functionality.

Consumers may wish for much more robust functionality that is currently unavailable in DSC models and memory cards. A consumer may wish to access a Wi-Fi hot spot requiring the input of a textual password. A consumer may wish to download to the memory card data or photos stored in a remote server. A consumer may wish to access an HTML webpage, for example a webpage displaying a street map to which the consumer's photos can be associated. A consumer may wish to manipulate an image in a way that the DSC cannot support, for example creating a photo thumbnail, and the like.

A DSC typically includes a user interface in the form of control buttons to receive user input as well as a display screen for output. For example, a camera usually has a shutter button to request a photo/video capture, a menu button to display a menu of available selections, a view/play selector to change the DSC mode from photo capture to photo view, next/previous buttons—used to request the next or the previous photo to view, a zoom button—used to zoom an image, a delete button to erase one or more photos and the like buttons. The DSC display screen is used to present photos and videos to the user and to present menus offering various management and configuration options. The handling of events triggered when the user activates a button or selects a menu item is managed exclusively by software executing in the DSC, and not the memory card.

U.S. Pat Application Ser. No. 2007/0073937 A1 by Feinberg, et al. describes a content-aware digital media card that includes wireless communication capabilities such as GPS and WiFi, which allow the card to communicate directly with a server in a WiFi hotspot and transfer data to the server. The card can record GPS data as well. This type of card is sold today by eye-fi (www.eye.fi), and allows a consumer to achieve certain improvements in functionality with a legacy DSC.

However, Feinberg et al. and eye-fi provide for a very limited set of functions for the content-aware media card, specifically focused on transfer of picture from the content-aware media card to a remote PC over a network.

Additionally, the content-aware card needs to be preconfigured to communicate with specific Wi-Fi networks. In unrecognized hotspots where a password is required, the memory card will not be able to connect to the network. Furthermore, a user may wish not to pre-configure a content-aware card because it entails storing password information either on the content aware card or on a remote server. Also, a user may wish not to pre-configure a content-aware card because the pre-configuration step entails coupling the card to a computer instead of configuring it while coupled to the host digital camera.

Another limitation of Feinberg et al. and eye-fi is the limitation of communication over Wi-Fi and similar networks, but not over a cellular network, which may have far greater coverage than Wi-Fi.

In order to provide a memory card with user input, for example a password to a hotspot, a DSC manufacturer could modify the software within the camera and add functionality to the user interface that requests textual input, for example requests a password for a hotspot. The problem with this approach is that it would require camera manufacturers to modify various models of cameras, some of which are out of production, and others that would require users to update their camera with the new features. This process is impractical both logistically as well as financially.

In another application, consumer electronic manufacturers, their business partners, or third parties may wish to subsidize the cost of a DSC, memory card, or other goods through an advertisement business model, for example by presenting an advertisement image on the DSC display when DSC is in playback mode. In order for the advertisements to be current and relevant, a connection to a remote ad server is desired, and the ability to incorporate an advertisement image with the DSC photo images is required.

Unfortunately, there is currently no solution in the art for the aforementioned feature requirements.

### SUMMARY OF THE INVENTION

The above-mentioned shortcomings, disadvantages and problems are addressed by the present invention, which will be understood by reading and studying the following specification.

An Active Storage Device, disclosed in this invention, is an improvement over a non-volatile memory card known in the art, due to its ability to perform processing and communication beyond the classic functionality of non-volatile memory cards. The capabilities of the Active Storage Device change the classic task distribution between a card and a DSC, as well as provide additional functionality to the DSC that has been previously unfeasible.

This invention further discloses the means of implementing a human interface component in an Active Storage Device, using existing DSC display and command buttons, such that new functionality is achieved without the need to approach the camera manufacturer for camera modification.

In one aspect of the invention, the Active Storage Device has at least the ability to receive user input, such as a text string, by generating synthetic images representing textual strings and allowing the user to act upon a synthesized image in order to add, delete, or edit a text character.

In some aspects of the invention, the Active Storage Device is coupled with a remote server over a wireless connection for the purpose of bi-directional data transfer.

In one aspect of the invention, the Active Storage Device has at least the ability to create thumbnail copies of photos taken by user and sending the originals to a remote server. This frees up substantial storage capacity on the Active Storage Device, while still enabling the user to view the photo thumbnail on the DSC display.

In one aspect of the invention, in response to geographical location information in a request from Active Storage Device to a remote server, the remote server transfers a map to the Active Storage Device.

In one aspect of the invention, the data is an advertisement sent from a remote server to the Active Storage Device for presentation on the DSC display.

In one aspect of the invention, in response to user provided text request sent from Active Storage Device to a remote server, the remote server executes a world wide web search and transmits the search results to the Active Storage Device.

The present invention describes an Active Storage Device and methods to increase the functionality of a DSC. In addition to the aspects and advantages of the present invention described in this summary, further aspects and advantages of the invention will become apparent by reference to the drawings and by reading the detailed description that follows.

### BRIEF DESCRIPTION OF THE DRAWING

FIG. 1 depicts a schematic block diagram of an embodiment of an Active Storage Device.

FIG. 2 depicts a schematic block diagram of an embodiment of an Active Storage Device controller.

FIG. 3 depicts a schematic block diagram of an embodiment of an Active Storage Device Operating System (ASDOS) components.

FIG. 4 depicts a schematic block diagram of an embodiment of an Active Storage Device File System.

FIG. 5 is depicts a schematic block diagram of a host Digital Still Camera (DSC)

FIG. 6 is a flow chart of an exemplary method of an Active Storage Device acting upon a user event.

FIG. 7 is a flow chart of an exemplary method of an Active Storage Device acting upon a user event to retrieve a synthetic image.

FIG. 8 is a flow chart of an exemplary method of using an Active Storage Device and host DSC to emulate keyboard input.

FIG. 9 is a flow chart of an exemplary method for a user selection of a Wi-Fi hotspot from a list of choices.

FIGS. 10A, 10B, 10C are exemplary user menus generated as synthetic images by an Active Storage Device to be presented as images on a host DSC display.

FIG. 11 depicts an embodiment of a system for remote services to a DSC over a network

FIG. 12 is a flow chart of an exemplary method of uploading photos from a DSC to a remote server.

FIG. 13 is a flow chart of an exemplary method of receiving a map from a remote server for presentation on a DSC display.

FIG. 14 depicts a schematic block diagram of an embodiment of a system for distributing advertisements to digital cameras.

### DETAILED DESCRIPTION OF THE INVENTION

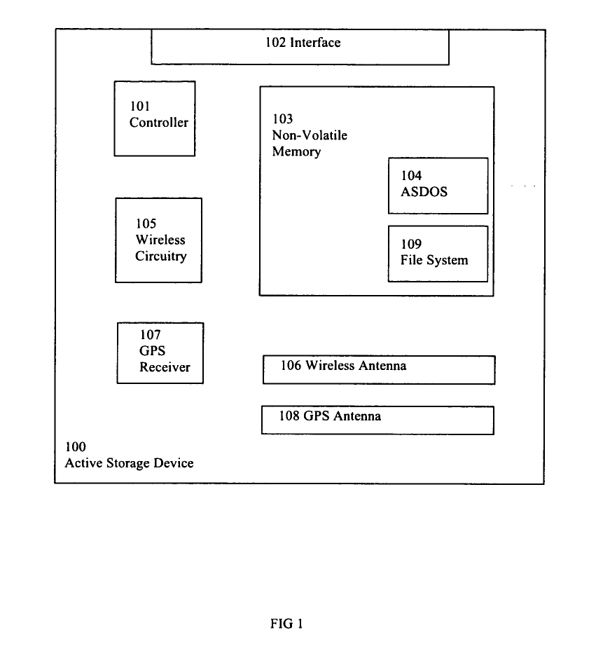

FIG. 1 depicts a schematic block diagram of an embodiment of an Active Storage Device 100, comprised of at least a controller 101, an interface 102 to a host digital appliance, and a non-volatile memory 103 that is adapted to store code. In some embodiments, the host digital appliance is a Digital Still Camera (DSC). In some embodiments, the host digital appliance is a digital video camera. In some embodiments, the host digital appliance is a mobile handset. Those skilled in the art will appreciate, that for the purpose of the present invention, a digital appliance may be any appliance with at least some DSC functionality, this invention is not so limited.

Interface 102 provides both a data exchange mechanism between Active Storage Device 100 and DSC and a power source for Active Storage Device 100. Interface 102 is a physical connection that complies with at least one standard format that exists in the art to connect a memory card to a digital camera in a physical, electrical, and data transfer aspect. Interface 102 may comply with one, or more of SD, Mini SD, Micro SD, SDHC, SDXC, CF, xD, Memory Stick, Memory Stick PRO, Memory Stick Duo, Memory Stick PRO Duo, Memory Stick PRO-HG Duo, Memory Stick Micro, or the like interface standards.

Non-volatile memory 103 stores data, which at least in part is shared and utilized by the host DSC and Active Storage Device 100. Non-volatile memory 103 is able to retain data even when Active Storage Device 100 is not powered.

Active Storage Device Operating System 104 (ASDOS) is software code that is stored in non-volatile memory 103. The ASDOS 104 may be loaded into the Active Storage Device 100 or the non-volatile memory 103 at production or at any time after the production of the Active Storage Device 100. ASDOS 104 may also be referred to as a content manager.

Non-volatile memory 103 is adopted to accept and retain at least the ASDOS 104 as well as audio-video information elements such as photos and videos that the user may capture using the DSC, or data otherwise acquired or manipulated by Active Storage Device 100, for example downloaded from a server. Non-volatile memory 103 is comprised of one or more components utilizing various storage technologies including but not limited to flash memory, backed up RAM, magnetic memory, optical memory, MRAM, NROM, ROM, and programmable ROM or any combination of these.

Some embodiments of the present invention may include a wireless circuitry 105 and a wireless antenna 106. Some embodiments may include a GPS receiver 107 and a GPS antenna 108. It may be appreciate by those skilled in the art that other embodiments may include additional components as required to add functionality to the host DSC without departing from the spirit of this invention.

Wireless circuitry 105 is comprised of elements required for wireless communications, such as WiFi, IEEE 802.11, WiMax, Bluetooth, GSM, CDMA, HSDPA, LTE, or the like wireless communications protocols. Wireless circuitry 105 may include analog circuitry for the handling of the wireless medium as well as digital circuitry for the handling of the wireless protocol. Wireless circuitry 105 is coupled to wireless antenna 106 for the actual transmission or reception of data. Wireless circuitry 105 is coupled to controller 101. In some embodiments, controller 101 triggers wireless communication activities.

GPS receiver 107 and GPS antenna 108 are comprised of elements required to receive, process and handle data used in determination of geographical location. GPS Receiver 107 is coupled to controller 101. In some embodiments, controller 101 triggers GPS activities.

File system 109 is a data structure stored in non-volatile memory 103 for the storage, organization, and retrieval of data.

Those skilled in the art may appreciate that a plurality of each of Active Storage Device 100's components may exist as well as that two or more components may be combined to form one component of larger scope, or a component might be split to form two or more components, the invention is not so limited.

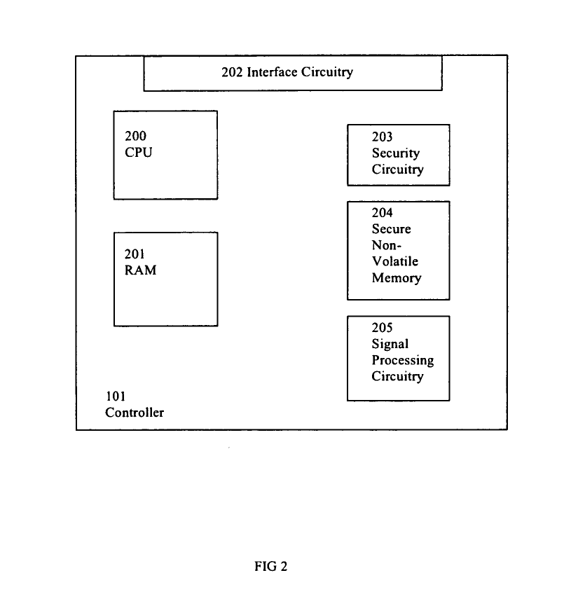

FIG. 2 depicts a schematic block diagram of an embodiment of an Active Storage Device controller. Controller 101 is comprised of at least the following components: a CPU 200 for executing code, Random Access Memory (RAM) 201 to store or cache code for execution, and interface circuitry 202 to be able to communicate with a host DSC through Interface 102 of Active Storage Device 100, for example circuitry that complies with one or more of the following protocols: Secure Digital (SD), Compact Flash (CF), Universal Serial Bus (USB), xD, Sony Memory Stick (MS) and the like interfaces.

In some embodiments, controller 101 is additionally comprised of security circuitry 203, such as an encryption engine, for example an AES engine and/or secret key generation circuitry and/or co-processing functions, and the like. In some embodiments, controller 101 is additionally comprised of secure non-volatile memory 204 internal to the controller, which may be utilized for storing secret codes. In some embodiments, controller 101 is additionally comprised of signal processing circuitry 205 utilized for photo processing or co-processing, for example to accelerate digital photo manipulation, such as creating a photo thumbnail.

Those skilled in the art may appreciate that a plurality of each of controller 101's components may exist as well as that two or more components may be combined to form one component of larger scope, or a component might be split to form two or more components, the invention is not so limited.

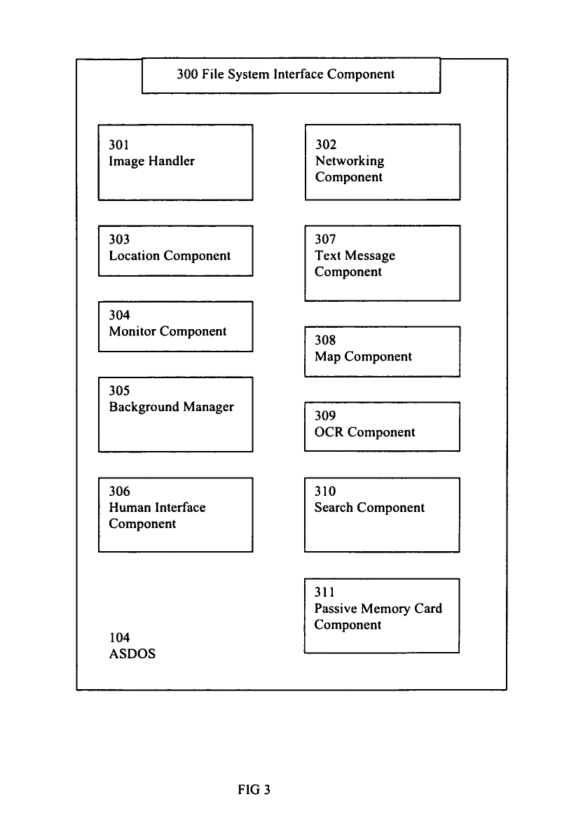

FIG. 3 depicts a schematic block diagram of an embodiment of Active Storage Device Operating System (ASDOS) 104 components. ASDOS 104 is at least code that is adapted to execute at least in controller 101, that extends the features of a DSC. ASDOS 104 may contain other code, for example emulating the behavior of a passive memory card. Passive memory card activities include its ability to store and retrieve data flowing from or to a DSC or any other computational device that can be coupled with a memory card, for example a personal computer.

ASDOS 104 is comprised of one or more file system interface 300, one or more image handler 301 and zero, one or more of at least the following components: a networking component 302, a location component 303, a monitor component 304, a background manager 305, a human interface component 306, a text message component 307, a map component 308, an OCR component 309, a search component 310, and a passive memory card component 311.

Those skilled in the art may appreciate that a plurality of each of the ASDOS 104 components may exist as well as that two or more components may be combined to form one component of a larger scope, or a component might be split to form two or more components, the invention is not so limited.

To better understand the function of each of the ASDOS 104 components, some background on the function of a passive memory card is presented here. In a configuration of a passive memory card coupled to a DSC, only the DSC bears the task of manipulating audio-video information elements such as photos. The task of the passive memory card is just to store and retain data. To achieve that, a passive memory card exposes addressable data blocks to a DSC. These are addressable locations of fixed length. A computational device, such as a DSC, couples with a memory card to move data to and from the non-volatile storage of the card in the form of data blocks. In order to manage files, the computational device coupled with the card maintains a File System that organizes the data blocks into files and directories. File system structures are known in the art and various implementations exist, for example FAT, FAT32, NTFS, HFS, HFS+, ext2, ext3, XFS, and the like. A passive memory card typically handles only data blocks, and thus does not have knowledge or access to files stored in the file system.

Image handler 301 component of ASDOS 104 is responsible for handling image data files—files containing a digital representation of at least audio-visual information elements such as photos, video clips, and the like. In some embodiments, image handler 301 modifies or otherwise processes the audio-visual content and/or metadata of an existing image data file. In some embodiments, information is added to the image data file such that when subsequently presented on the host DSC, the user will recognize that the image presented has been processed, for example by adding a small icon or logo at the bottom right corner of the image. In some embodiments, image handler 301 generates synthetic images. A synthetic image is an image data file created for presentation on a DSC display that was not captured by the DSC's optics.

In some embodiments, image handler 301 receives image data files that were transmitted from a remote server. In some embodiments it creates photo files on the file system, for example in order for those to be accessible by the DSC. In some embodiments it replaces exiting photo files with other photo files. In some embodiments, image handler 301 is triggered when the DSC captures a new photo file and stores it in the file system. In some embodiments, image handler 301 optionally verifies that the file is a valid photo. In some embodiments, image handler 301 designates an image data file for uploading to a remote server. In some embodiments, image handler 301 replaces an image data file with a thumbnail—a photo file containing the same visual information but requiring much less memory storage space. In some embodiments, image handler 301 creates the thumbnail. In some embodiments, image handler 301 receives a thumbnail that was downloaded from a remote server. In some embodiments, image handler 301 replaces the original photo with the thumbnail in order to free space in the non-volatile memory 103, or the like operations, all with the purpose of optionally freeing local storage while keeping a copy of the original file remotely for future viewing purposes. In some embodiments, information is added to the thumbnail such that when subsequently presented on the host DSC, the user will recognize that the image presented is not the original, for example by adding a small icon or logo at the bottom right corner of the image.

In some embodiments, image handler 301 may create, request for download from a remote server, or otherwise acquire an image data file which it stores in file system 109 for the purpose of making it available for presentation to the user through the DSC display, for example a branded image displaying a logo. In some embodiments, image handler 301 modifies an existing image in the file system, for example in order to add a signature or watermark. In some embodiments, image handler 301 may delete photos after they are transferred to a remote server for the purpose of freeing local storage space.

Networking component 302 provides communication services. In some embodiments, it is able to connect wirelessly to a communications network, for example a Wi-Fi hotspot, and ultimately provide Active Storage Device 100 with access to the Internet, and through it to remote services. For example, in some embodiments, once connected to the Internet, and when requested, networking component 302 initiates communications with a predefined remote server, for example a photo storage server, with the purpose of transferring photos to that server. In another embodiment, networking component 302 logs into a remote server requiring input of username and password. In another embodiment, networking component 302 creates a new user account on the server based on a predefined possibly unique number. In another embodiment, networking component 302 contacts a first server in a chain of servers in order to receive a reference to a second server and possibly the chain proceeds until the last server in the chain is connected. In another embodiment, networking component 302 receives a list of remote servers to select from. In some embodiments, networking component 302 transfers at least a file to a remote server. In some embodiments networking component 302 receive at least a file from a remote server. In some embodiments, the transfer of files and/or data is amended by a command and/or configuration data. In some embodiments, the transferred files are stored or read from non-volatile memory 103.

Location component 303 of ASDOS 104 provides location information based on inputs from the GPS receiver 107. In one embodiment, location component 303 retrieves geographic information from GPS receiver 107 and provides it to image handler 301 in order to store it in a file.

Monitor component 304 of ASDOS 104 provides the service of monitoring for events such as data flowing through interface 102 or changes to file system 109. In some embodiments, monitor component 304 monitors file system 109 for the creation of new files. In some embodiments, monitor component 304 monitors file system 109 for the removal of files. In some embodiments, monitor component 304 monitors the outbound data flow through interface 102 when the coupled DSC is reading data from Active Storage Device 100. In some embodiments, monitor component 304 combines the information of the data being read with information from file system 109 to decide which file is being read. In some embodiments, monitor component 304 monitors the inbound data flow through interface 102 when the coupled DSC or computational device is writing data. In some embodiments monitor component 304 combines the information of the data being written with information from the file system to understand what file is being written. In some embodiments, various actions may be triggered as a result of one or a combination of the above events.

Background manager 305 manages activities that do not require immediate user attention, for example the transfer of files through the networking component 302, or the generation of a thumbnail. In some embodiments, background manager 305 handles the transfer of a group of photo files that were previously designated for transmittal. In some embodiments, background manager 305 handles cases where a previous photo transmittal session was incomplete. In some embodiments, background manager 305 keeps track of photos already transmitted. In some embodiments, background manager 305 designates a file as having been transmitted. In some embodiments, background manager 305 receives files and/or photos and/or thumbnails of the photos. In some embodiments, background manager 305 manages the generation of a thumbnail.

Human interface component 306 of ASDOS 104 is responsible for accepting input and providing output to the user. Human interface component 306 receives and transmits information through one of several endpoints: a host DSC, a computing device to which the DSC is connected, a computing device to which Active Storage Device 100 is connected through a card reader, the network and/or any other device that can be used for human interface. Human interface component 306 decides which information is to be provided to the user and what process a user action has to trigger. In some embodiments, human interface component 306 uses image handler 301 and/or monitor component 304 and/or other ASDOS 104 components to execute the transfer of information to and/or from the user.

Text message component 307 of ASDOS 104 is responsible for handling messages to be sent to an email address and/or to be sent as SMS messages to a cellular phone. Text message component 307 handles the triggering of input of messages, management of addresses and phone numbers and the triggering of transmission or reception of the message. In some embodiments, text message component 307 formats a message containing one or more email addresses and/or one or more cellular phone numbers and/or one or more text messages to be transmitted to a remote server. In some embodiments, text message component 307 retrieves a message from a remote server with one/or more text message to be later displayed to a user when the host DSC is in playback mode.

Map component 308 of ASDOS 104 is responsible for retrieving and displaying geographic data to the user. In some embodiments, map component 308 formats a message containing a geographic location to be transmitted to a remote server. In some embodiments, map component 308 retrieves an image of a map from a remote server. In some embodiments, map component 308 formats a message containing a user-selected location to be transmitted to a remote server and retrieves an image of a map of the user-selected location vicinity. In some embodiments, the map is displayed when the host DSC is switched to playback mode.

OCR component 309 of ASDOS 104 is responsible for producing text information from visual photo information. In some embodiments, a photo captured by the user is analyzed to retrieve any text found in the visual information. In some embodiments, OCR component 309 performs the analysis. In some embodiments, OCR component 309 orchestrates the transmission of the visual information and/or a request to process the visual information to a remote server and orchestrates the reception of the resulting text from a remote server. In some embodiments, the text retrieved is presented to the user on a host DSC display when in playback mode.

In some embodiments, the text retrieved is used to produce a World Wide Web search query by search component 330 of ASDOS 104. In some embodiments, the text retrieved is used to produce a text message and/or an address and/or a cellular phone number and/or a plurality of those to be used by text message component 307 of ASDOS 104.

Passive memory card component 331 fulfills passive memory card functionality as known in the art. For example, passive memory card component 331 receives and transfers data blocks from non-volatile memory 103 to a host DSC.

The ASDOS 104's capability to expand a host DSC's functionality is based on the fact that the host DSC and the Active Storage Device 100 both control a shared resource—at least some of the data on the non-volatile memory 103 of Active Storage Device 100. This data comprises at least of file system 109 which at least contains photos or videos captured by the DSC. By analyzing the events taking place on file system 109 and/or by reading or writing to file system 109, ASDOS 104 may deduce the user actions and derive from that what to do next. Similarly, by modifying data in file system 109, ASDOS 104 may pass output to the user through the DSC.

In prior art, a memory card provides a so-called “block device interface” to a computational device that accesses the memory card's non-volatile memory. For example, in a DSC coupled to a passive memory card, an interface that enables it to read or write “blocks”—chunks of data of a predefined size—to a selected location in the memory. The DSC maintains a file system, which is a data structure used in the art to manage files and is based on the block device attribute of the memory card. The file system has a header that maps the various blocks in the memory card into files. Conceptually, the header contains a list of files, mapped with file names and each holding a list of blocks that hold the file data. File system structures are known in the art and various implementations exists, for example FAT, FAT32, NTFS, HFS, HFS+, ext2, ext3, XFS, and the like.

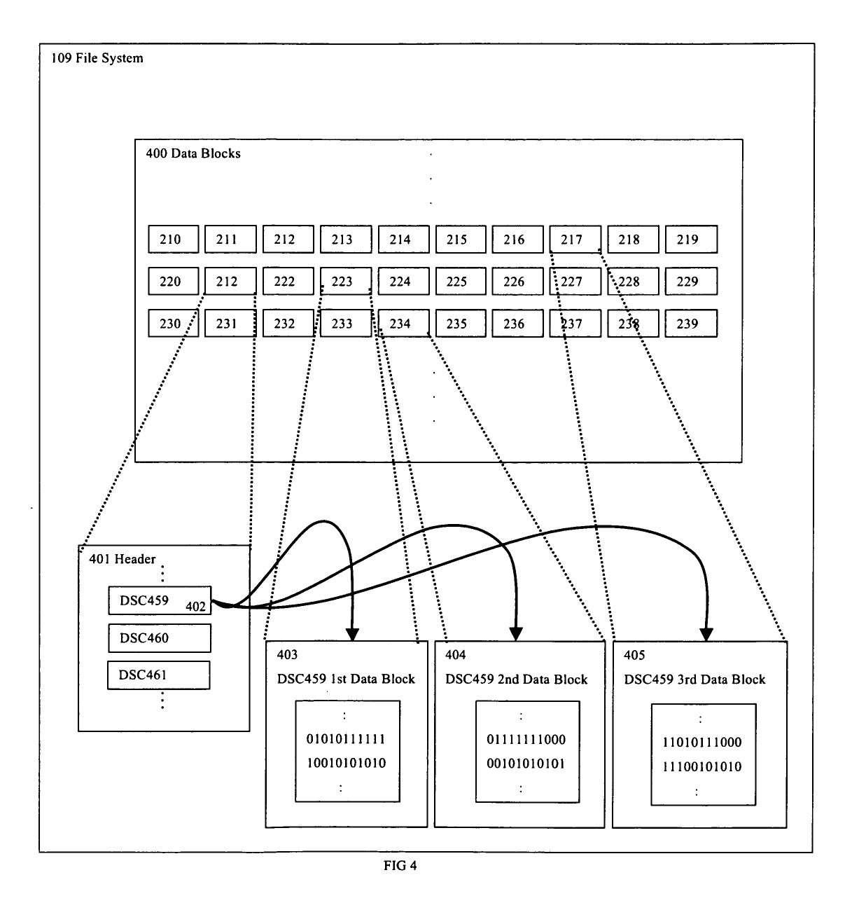

FIG. 4 depicts a schematic block diagram of a section of an embodiment of a file system 109 storing files on non-volatile memory 103 of Active Storage Device 100. As mentioned above, a file system is a data structure that organizes files on fixed sized blocks of memory (memory blocks). In FIG. 4, data blocks 400 are those fixed sized blocks of memory. Some of data blocks 400 are designated for a header, which may be used to keep track of file names as well as references to blocks of memory that store files' content. Header 401 shows the contents of memory block #212 in data blocks 400 which contains at least part of the file system header itself. Header 401 holds entries of several image data files referred to as DSC459, DSC460, and DSC461. Each entry contains at least some of the attributes of an image data file, for example the image data file name, length, as well as references to an ordered list of memory blocks that hold the file data. DSC459 402 is the file name of the digital representation of a photo captured by a host DSC. DSC459 402 refers to memory blocks #223, #234 and #217 to store DSC459 1st data block 403, DSC459 2nd data block 404, and DSC459 3rd data block 405, respectively. DSC459 1st data block 403, DSC459 2nd data block 404, and DSC459 3rd data block 405 contain DSC459 402's data.

Traditionally, a DSC performs one of four major operations in connection to a file system that is located on a passive memory card: write a file—for example when a photo is captured; read a file—for example when viewing a captured photo on the DSC display; delete a file—when the user elects to delete one or more files; and format and/or reformat—when the file system is reset to an empty state, for example with the file system structures in place but no files stored.

In the following descriptions, methods of using file system 109 as a shared resource of both a host DSC and Active Storage Device 100 in order to enhance DSC functionality are detailed. One such enhancement is extending the human interface functionality. Those skilled in the art may appreciate that the referred embodiments and scenarios of operation are provided as exemplary embodiments and scenarios for the purpose of discussion and description of methods. Additionally, those skilled in the art may appreciate that the methods described herein are exemplary methods and may vary due to permutations of embodiments or may be implemented in permutation of order or events; the invention is not so limited.

In some embodiments, Active Storage Device 100, by way of ASDOS 104 executing monitor component 304, may conclude that a new image data file whose entry in header 401 is DSC459 402 is being created in file system 109 by the host DSC (for simplicity of discussion, hereafter the file whose entry in header 401 is DSC459 402 will be referred to as data file DSC459 402). By sensing the number and location of DSC459 1st data block 403, DSC459 2nd data block 404, and DSC459 3rd data block 405 being written to Active Storage Device 100 by the host DSC, it determines that a new image data file DSC459 402 was created. In some embodiments, ASDOS 104 monitors file system 109's structure and identifies that a new image data file DSC459 402 was added. In some embodiments, ASDOS 104 verifies that the image data file DSC459 402 created is indeed a valid photo file. In some embodiments, ASDOS 104 verifies that the name of the image data file DSC459 402 as stored in file system 109 complies with the standard naming convention used by the particular host DSC. In some embodiments, Active Storage Device 100 may deduce one or more attributes of the host DSC by analyzing the image data file DSC459 402 name and/or file content and/or folder structure that the DSC uses to store photo and video files. For example it may deduce the model of the DSC. In some embodiments, additional means are used to determine that a new image data file DSC459 402 was added, through the observation of file system 109, for example, by monitoring the amount of unused data blocks 400 and/or the flow of data blocks 400 through interface circuitry 202.

In some embodiments, the addition of a new image data file DSC459 402 leads to the conclusion that the host DSC shutter was pressed.

In some embodiments, ASDOS 104 may conclude that an image data file DSC459 402 is being read, by monitoring the block device interface of passive memory card component 311, and by sensing the number and location of data blocks 400 being read from non-volatile memory 103. The amount and location of these data blocks 400 may be compared to the information in file system 109 to conclude which image data file DSC459 402 is the one being read.

In some embodiments, ASDOS 104, by monitoring the block device interface of passive memory card component 311 and concluding that image data file DSC459 402 is being read, deduces that the host DSC has been switched to playback mode.

In some embodiments, Active Storage Device 100 may conclude that a file was deleted from file system 109 by monitoring file system 109 and identifying that image data file DSC459 402 was removed, was marked to be removed, or was erased from file system 109. In some embodiments, Active Storage Device 100, through ASDOS 104, monitors that a file name was removed from header 401 to conclude that an image data file was deleted. In some embodiments, Active Storage Device 100 concludes that all the bits of image data file DSC459 402, in DSC459 1st data block 403, DSC459 2nd data block 404, and DSC459 3rd data block 405, were set to zero to conclude that a file was deleted. In some embodiments, additional means are used to determine that a file was removed. For example, ASDOS 104 observes file system 109, identifying that the data blocks 401 allocated to a file are being accessed and/or are being erased and/or having their content modified. In some embodiments, the deletion of a image data file DSC459 402 leads Active Storage Device 100 to conclude that the user pressed the DSC delete button.

In some embodiments, Active Storage Device 100 may conclude that file system 109 was formatted or re-formatted by monitoring and discovering that file system 109 contains no files. In some embodiments, Active Storage Device 100 does so by verifying a file counter and/or file counters in file system 109. In some embodiments, it concludes that file system 109 was formatted by verifying that the data in the card is fully or partially zeroed out. In some embodiments, Active Storage Device 100 does so by using passive memory card component to monitor the write operations on the block device interface

In some embodiments, when an image data file DSC459 402 is created, Active Storage Device 100 analyzes the visual data in the file, and attempts to determine if there exists text in the photo. In some embodiments, Active Storage Device 100, using OCR component 309, extracts the text from the photo using OCR (Optical Character Recognition) techniques. In some embodiments, Active Storage Device 100 acts upon the extracted text, for example uses it to send a World Wide Web search query, using search module 310. In some embodiments, Active Storage Device 100 uses the extracted text as an input command or data for further actions, for example as a password to log onto a Wi-Fi hotspot.

In some embodiments, Active Storage Device 100 is triggered by the creation of an image data file DSC459 402 and initiates a transfer of one or more files, for example the photo file and/or other photo files and/or a command file and/or a message to a remote server. In some embodiments, Active Storage Device 100 retrieves one or more files from a remote server, for example photo files and/or command files, in response to the transferred files. In some embodiments, following a trigger, an image data file DSC459 402 is marked for transfer and/or other possible actions to be completed at a later time.

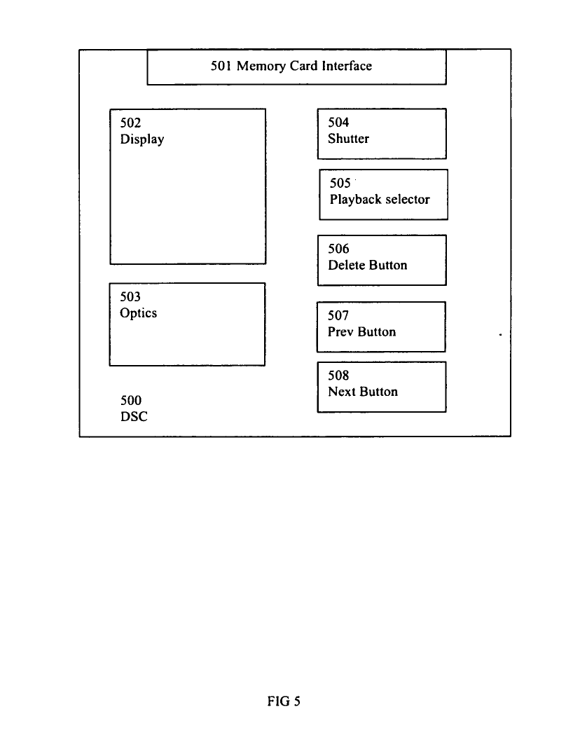

FIG. 5 is depicts a schematic block diagram of a host Digital Still Camera (DSC) 500. DSC 500 is an exemplary DSC model that is known in the art and whose functionality can be improved by way of the present invention. Memory Card interface 501 provides both power and data to a coupled memory card. Those skilled in the art will appreciate that instead of a standard memory card, Active Storage Device 100 may be used. Display 502 is a visual presentation means utilized by the consumer to view captured photos, DSC menus, and monitor DSC 500 information such as battery level, and the like.

Optics 503 converts visual information to digital data that can be stored in a memory card. Shutter 504 is a user control to have DSC 500 capture a photo. Existing art describes captured photos being stored in a memory card coupled to DSC 500. Playback selector 505 is a user control switching DSC 500 between photo capture mode and photo presentation mode. Existing art describes photos, also known as image data files, fetched from the coupled memory card and presented according to their capture sequence on Display 502. Delete button 506 is a user control used to delete currently presented image data file from a memory card coupled to DSC 500. Prev button 507 is a user control for presenting the previous image data file when DSC 500 is set to playback mode. Next button 508 is a user control for presenting the previous image data file when DSC 500 is set to playback mode.

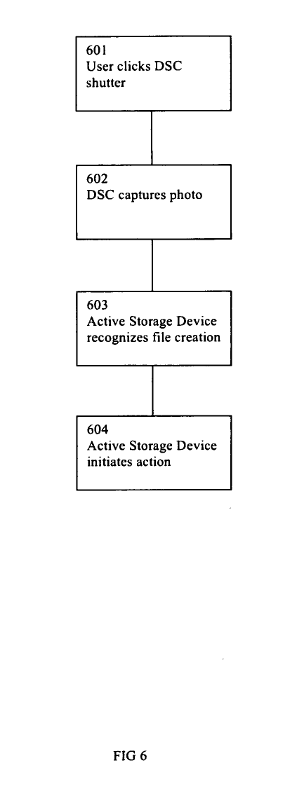

FIG. 6 depicts an exemplary method of Active Storage Device 100 acting upon a user event—host DSC shutter pressed to capture a photo. In step 601 the user initiates the action by clicking the shutter button, triggering the host DSC to capture a photo. In step 602, the host DSC captures the photo and uses the block device interface to store it's digital image file onto file system 109 on Active Storage Device 100. In step 603, Active Storage Device 100, monitoring for input, recognizes that a file is being created. In step 604, Active Storage Device 100 initiates an action of transmitting the photo to a remote server. It may be appreciated by those skilled in the art that various other actions, such as mark for further action, thumbnail creation, OCR check, Wi-Fi connection attempt, or any other action may be initiated by Active Storage Device 100, this invention is not so limited.

In some embodiments, Active Storage Device 100 generates and stores one or more image data files in file system 109, so that at a later time one or more photos will be retrieved and presented on the host DSC display when in playback mode. In some embodiments, Active Storage Device 100 stores in file system 109 images that were downloaded from a remote server.

In some embodiments, Active Storage Device 100 replaces an image data file in file system 109 with a different file, for example a smaller sized copy of the original photo, or a thumbnail version. In some embodiments, Active Storage Device 100 stores files that were received from a remote server in file system 109.

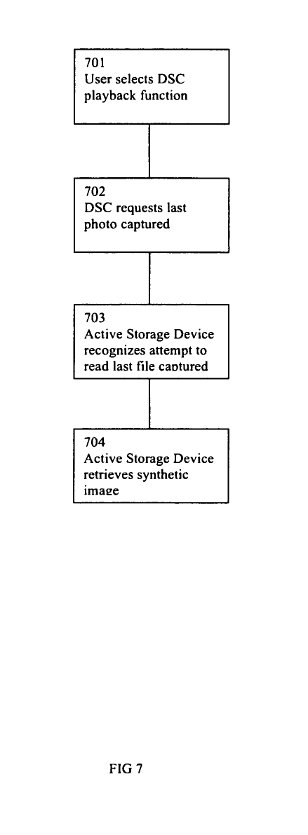

FIG. 7 depicts an exemplary method of Active Storage Device 100 acting upon a user event—host DSC switched to playback mode. In step 701, the user initiates the action by selecting the photo playback function of the host DSC. In step 702, the host DSC attempts to retrieve the last photo captured. In step 703, Active Storage Device 100 recognizes an attempt to read the last file captured by the host DSC. In step 704, Active Storage Device 100 retrieves instead of the last file captured, a synthetic image and transmits it to the host DSC for presentation to the user on the DSC display.

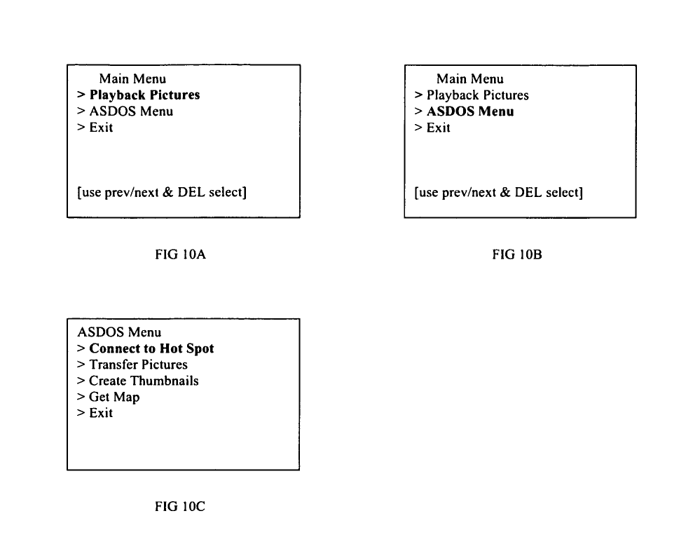

A synthetic image is an image data file intended for presentation on a DSC display that was not captured by the DSC's optics. In some embodiments, the synthetic image is a branded welcome note, for example an image with a company logo such as Facebook, Coca-Cola, Yahoo!, and the likes. In some embodiments, the synthetic image contains some status or instructional information. In some embodiments, the synthetic image is a top level menu, such as in FIG. 10A. In some embodiments, the synthetic image may be retrieved from a remote server, for example an advertisement. In some embodiments, instead of a synthetic image, Active Storage Device 100 retrieves a video file, a map, an email, an SMS, a part of a web page, or any other data that may be useful to the user, this invention is not so limited.

Active Storage Device 100's ability to modify file system 109, and to generate, download or otherwise acquire synthetic images, can be used to display messages, instructions, and the like to the DSC user. In some embodiments, the images that may be displayed to the user are a set of alphanumeric characters, for example for the purpose of creating a virtual keyboard. In some embodiments, the letters and/or digits and/or other symbols are stored in non-volatile memory 103. In some embodiments, a list of the letters and/or digits and/or other symbols are stored in file system 109. When the user selects playback mode on the host DSC, one of the images representing an alphanumeric character is displayed. The user may select “next” or “previous” picture on the host DSC to browse through the characters. In some embodiments, when a character of choice is displayed, the user may select the “delete” function of the host DSC, instructing the DSC to delete the file. Active Storage Device 100 then recognizes that a specific character image was selected for removal. In some embodiments, when the user selects a character image for removal, Active Storage Device 100 assumes that the user wishes to choose this character as if it were keyed in on the virtual keyboard. By choosing successive characters, the user may input a password, a website URL, or any other alphanumeric information to be processed by Active Storage Device 100 for the purpose of providing additional services to the user, such as connecting to a Wi-Fi hotspot that requires a login password, presenting a map or website on the DSC display, or any other purpose, this invention is not so limited. Those skilled in the art can appreciate that by creating a mechanism such as described for user input, the utility of the DSC to the user is greatly enhanced.

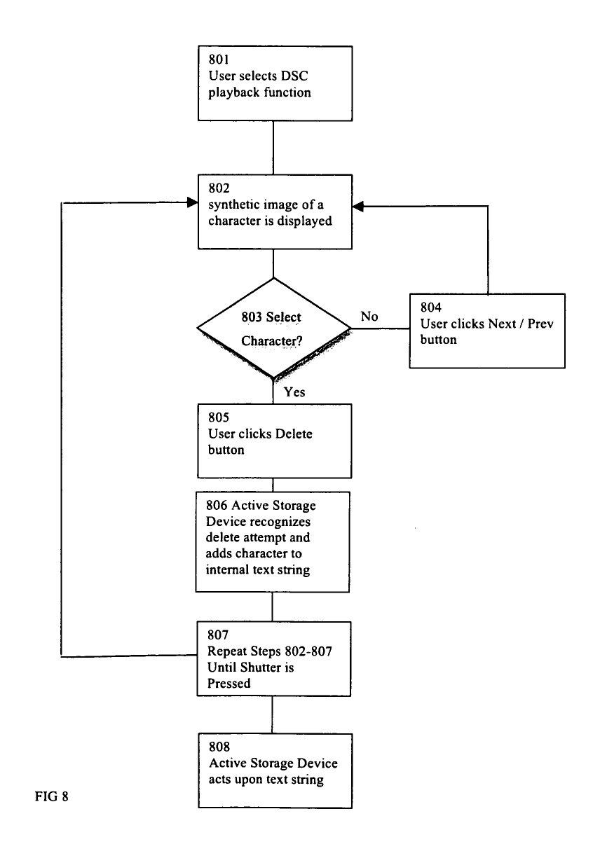

FIG. 8 is a flow chart of an exemplary method of using Active Storage Device 100 coupled to a host DSC to emulate keyboard input. In step 801, the user initiates the action by selecting the photo playback function of the host DSC. In step 802, a synthetic image, presenting a character, is displayed. In step 803, user decides whether to select the character or not. In step 804, the user clicks on previous or next buttons on the host DSC to select an alternative character and step 802 is repeated. In step 805, the user clicks the delete button on host DSC to indicate selection of the displayed character. In step 806, Active Storage Device 100 adds the selected character to an internal text string. In step 807, Active Storage Device 100 senses if the shutter has been pressed, an event that represents end of user input. If such an event is not recognized, step 802-807 are repeated. In step 808, Active Storage Device 100 acts upon the text string received as input from the user, for example sending a password to a Wi-Fi hotspot server.

In some embodiments, a set of synthetic images containing names of available wireless hotspots is created. In some embodiments, the user may browse through the photos with names of available hotspots when the camera is in viewing mode. In some embodiments, the user may select the DSC delete function when the name of the particular hotspot of choice is displayed. In some embodiments, the attempted deletion of an image containing a hotspot name may signal the selection of that hotspot by the user. In some embodiments the letters and/or digits and/or symbols and/or status and/or instruction messages are transmitted for display as required or otherwise retrieved, and not stored in file system 109, the invention is not so limited.

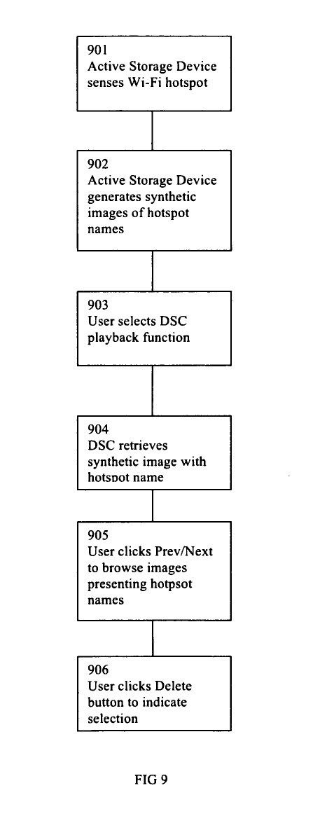

FIG. 9 depicts a flow chart of an exemplary method for a user to select a hotspot of choice. In step 901, Active Storage Device 100 senses a set of Wi-Fi hotspots available for coupling. In step 902, Active Storage Device 100 generates a set of synthetic images, each containing at least the name of one available hotspot. In step 903, the user selects DSC playback mode. In step 904, the host DSC attempts to retrieve the last photo captured and in actuality retrieves an image presenting a hotspot name. In step 905, the user browses through the images with hotspot name using the Prev/Next buttons of the host DSC. In step 906, the user clicks the delete function on the DSC to indicate selection of the hotspot whose name is presented on the DSC display.

FIGS. 10A, 10B, 10C are exemplary user menus generated as synthetic images by an Active Storage Device to be presented as images on a host DSC display. FIG. 10A depicts an image of a menu that is sent from Active Storage Device 100 to its host DSC. The image display was triggered by a user action, for example switching the host DSC to playback mode. In the menu, the user is presented with 2 options, where “Playback Pictures” is highlighted. The user can select this option by pressing the DSC delete button.

By clicking on the DSC next button, the user can highlight option “ASDOS Menu” as seen in FIG. 10B. The next button action by user triggers Active Storage Device 100 to transfer a slightly different synthetic image to the DSC display, creating user experience similar to that of a computing device display such as a computer monitor, mobile phone, and the like.

FIG. 10C depicts another synthetic image of a menu, specifically a menu for managing extended functionality not present in the host DSC. The user may choose to connect to a wireless hotspot, transfer pictures to a remote server, create thumbnail images, or get a map.

In some embodiments, synthetic images may be predefined and shipped with Active Storage Device 100. In some embodiments, Active Storage Device 100 may generate synthetic images on the fly. In some embodiments, a remote server may generate synthetic images and transmit them to Active Storage Device 100. In some embodiments, any combination of the above is possible.

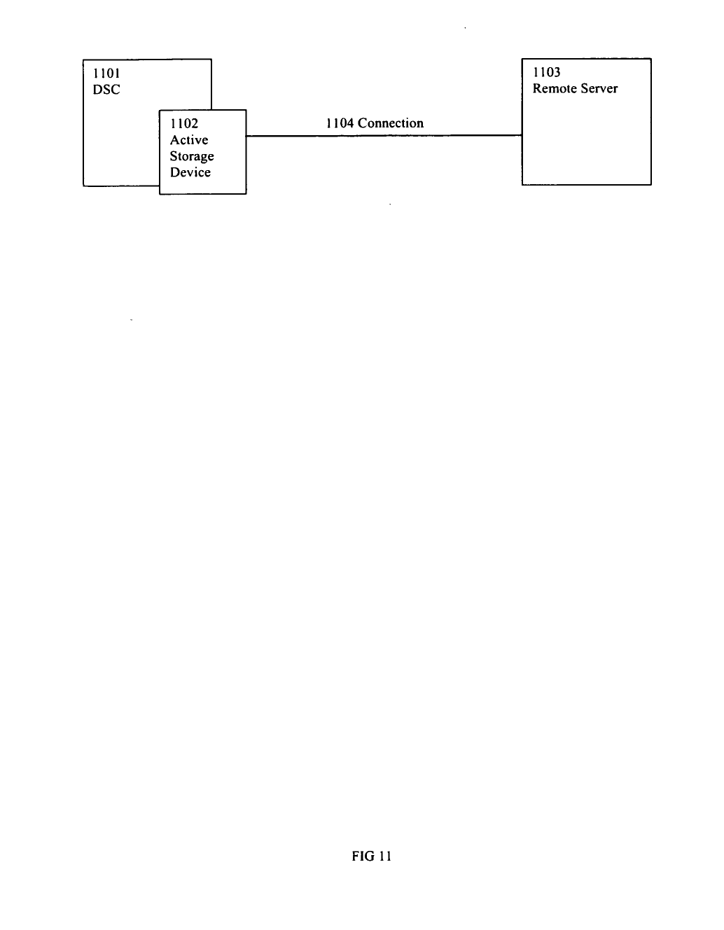

FIG. 11 depicts an embodiment of a system for remote services to a DSC over a network. DSC 1101 is a digital still camera with at least the capacity to capture photos as well as to couple with an Active Storage Device 1102. In some embodiments DSC 1101 is a camera functionality integrated into a consumer electronics device, such as a video camera or a mobile phone. Active Storage Device 1102 is a digital media storage device that has access to the photos captured by DSC 1101 and is able to connect to the Internet.

In some embodiments, Active Storage Device 1102 has a wireless circuitry enabling it to connect to a wireless network through a connection 1104, for example to a Wi-Fi hotspot, a WiMAX network, a cellular network such as GSM, or the like wireless networks. In some embodiments, Active Storage Device 1102 senses an available network to be attached to and attaches autonomously to that network. In some embodiments, the user selects which network to attach to. In some embodiments, the user presets the attributes of a choice of the network.

Remote server 1103 is a remote computational device that has at least the ability to accept data from another computational device through a network. In some embodiments, remote server 1103 is composed of a single server. In some embodiments, remote server 1103 is composed of a plurality of computational devices, a plurality of servers, or that are not necessarily compound into one entity, the invention is no so limited. In some embodiments, remote server 1103 is adopted to accept at least an image files from Active Storage Device 1102. In some embodiments, remote server 1103 is adopted to transmit at least an image file to Active Storage Device 1102. In some embodiments, remote server 1103 is adopted to transmit to and/or receive from Active Storage Device 1102 a video file, a text file, a text message, a street map, a web page, and any other digital information, this invention is not so limited.

In some embodiments, remote server 1103 includes a directory service that indicates which server is to be used for what service. In some embodiments, remote server 1103 includes a middleware server that translates and adjusts information between Active Storage Device 1102 and remote server 1103 that provides a service. In some embodiments remote server 1103 manages user accounts to separate data of different users.

In some embodiments Active Storage Device 1102 logs into a predefined account in a remote server 1103. In some embodiments, Active Storage Device 1102 requests a new user account created on remote server 1103 based on a unique serial number of the card. In some embodiments, the user may configure Active Storage Device 1102 to include one or more user account credential which may be used to login to a server. In some embodiments, remote server 1103 includes a photo backup service.

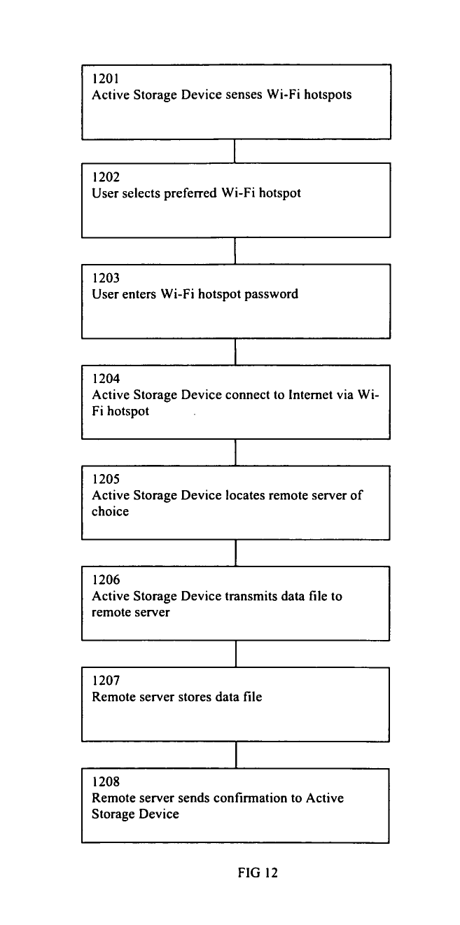

FIG. 12 is a flow chart of an exemplary process of uploading data to remote server 1103, for example for backup purposes. The user employs a DSC coupled with Active Storage Device 1102 and wishes to backup photos to remote server 1103.

In step 1201, Active Storage Device 1102 recognizes one or more wireless hotspots available. In step 1202, the user selects a preferred wireless hotspot by browsing synthetic images created by Active Storage Device 1102. In step 1203, user enters the hotspot password, for example by following steps described in FIG. 8. In step 1204, Active Storage Device 1102 attaches to the Internet, through the selected wireless network. In Step 1205, Active Storage Device 1102 locates the server of choice. The server of choice may be predefined in the card and/or configured by the user prior the attachment and/or selected through a directory service and/or selected by the user at time of attachment, this invention is not so limited. Once remote server 1103 is located, the Active Storage Device 1102 logs into the required account. In step 1206, the Active Storage Device 1102 transmits a data file to remote server 1103. In some embodiments, the data file is a photo. In some embodiments, the data file is a video file, a text file, an audio file, or any digital media file, this invention is not so limited. In step 1207 remote server 1103 stores the data in a repository, thus creating a backup. In step 1208, remote server 1103 sends a confirmation message to Active Storage Device 1102 signaling to proceed with the next data file. Steps 1206 to 1208 are then repeated until all data files have been transmitted to remote server 1103.

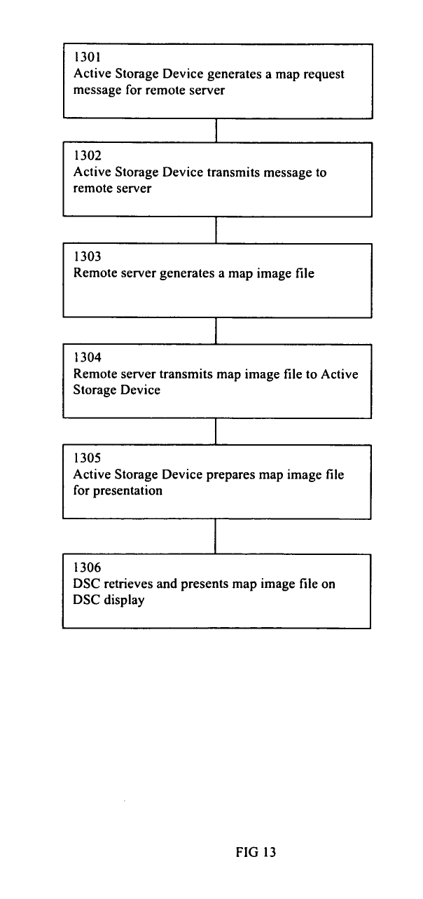

In some embodiments remote server 1103 includes a mapping service. FIG. 13 is a flow chart of an exemplary method of receiving a map from remote server 1103 for presentation on a DSC display.

In step 1301, Active Storage Device 1102 generates a message for remote server 1103 comprising present location of Active Storage Device 1102 as retrieved from its GPS component and a request to receive a map of present location vicinity. In some embodiments, a different location is specified. In step 1302, the Active Storage Device 1102 transmits the message to remote server 1103. In step 1303, remote server 1103 accepts the message and generates a response in the form of the requested map as an image file. In step 1304, remote server 1103 transmits the map as an image file to Active Storage Device 1102. In some embodiments, the requested map may be sent an HTML web page, for example a Google Maps webpage. In step 1305, Active Storage Device 1102 accepts the image file and sends it for presentation on host DSC display. In step 1306, the DSC retrieves the map image file from the card and presents it on the DSC display.

In some embodiments, remote server 1103 is at least middleware for a map service. For example, remote server 1103 accepts a request from Active Storage Device 1102, transforms it into a request to a map service, and receives map information as a response. The map information may be a visual form, an abstract form, or any other form for modeling a map. The middleware converts the received data into an image file and transmits it to Active Storage Device 1102. In some embodiments, a plurality of messages, responses, and/or map information files is exchanged.

Remote server 1103 may further include a search service. In some embodiments, remote server 1103 receives search requests from Active Storage Device 1102, and then generates or otherwise acquires results from the search request and transmits one or more results as image files back to Active Storage Device 1102 as search results.

Remote server 1103 may further include a text messaging service. In some embodiments, remote server 1103 receives text messages and destinations, such as mobile phone numbers or email addresses, from Active Storage Device 1102, and initiates the process of sending the messages to their respective destinations. For example, if the destination is an email, the server initiates an email transmission. For example, if the destination is a phone number, the server initiates an SMS transmission.

In some embodiments, remote server 1103 creates thumbnails of images received from Active Storage Device 1102. Thumbnails are smaller scale photos and thus smaller in the required storage size, yet maintain the same visual content of the original photo when viewed on a small display, such as that of a DSC. In some embodiments, Active Storage Device 1102 retrieves processed photos from remote server 1103. In some embodiments, Active Storage Device 1102 retrieves thumbnails of the photos previously transmitted to remote server 1103 for backup. In some embodiments, Active Storage Device 1102 thumbnails replace the original photos in order to free up local storage space for new photos, for example photos captured by the host DSC. In some embodiments, the user may access remote server 1103 at a later occasion to retrieve the photos. The access may be from Active Storage Device 1102 or any other computational device.

In some embodiments, remote server 1103 and Active Storage Device 1102 may exchange emails, SMS, MMS, or other types of messages, this invention is not so limited. In some embodiments, these messages may be used in online services such as Facebook, flicker, AIM, and the like.

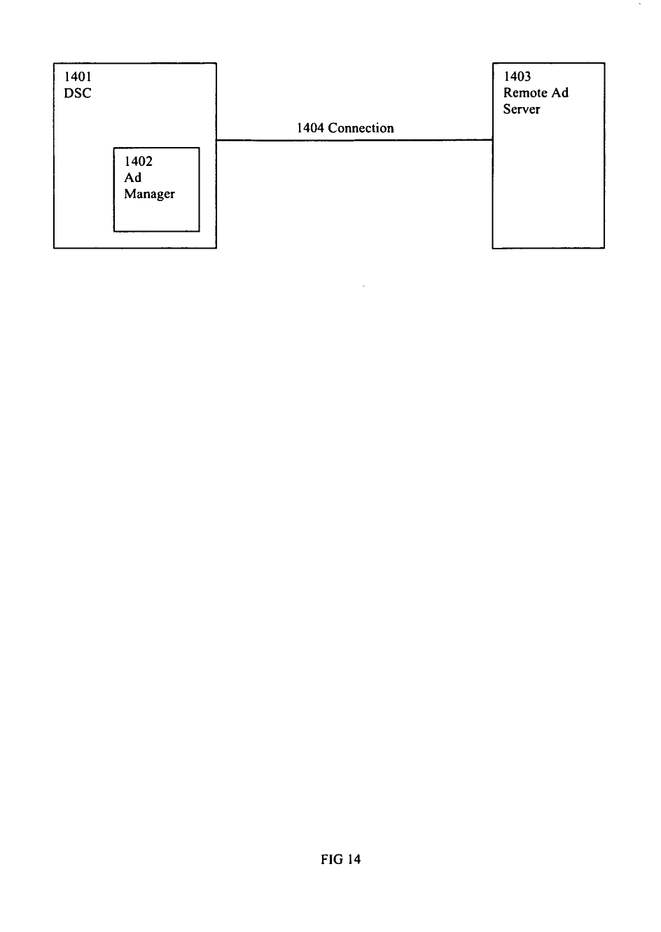

FIG. 14 depicts a schematic block diagram of an embodiment of a system for distributing advertisements to digital cameras. DSC 1401 is a digital camera able to connect to the Internet. DSC 1401 includes at least an ad manager 1402. In some embodiments, ad manager 1402 is a configuration of ASDOS 104. In some embodiments, an Active Storage Device, which may include wireless capabilities, is coupled to DSC 1401. In some embodiments, ad manager 1402 may be present in the Active Storage Device and not in DSC 1401. Ad manager 1402 is responsible for retrieving, processing, and preparing for presentation the advertisement information. In some embodiments, ad manager 1402 receives photos from a remote server. In some embodiments, ad manager 1402 receives data and converts it into an image data file.

Remote ad server 1403 is a server that is able to generate, transform or otherwise acquire advertising information and distribute it, possibly after processing. Connection 1404 is the means of communication between remote ad server 1403 and ad manager 1402, for example the Internet.

In some embodiments, remote ad server 1403 acquires advertisement information and converts it into image data files to be presented on the DSC 1401 display. In some embodiments, remote ad server 1403 stores image data files and retains them for distribution. In some embodiments, remote ad server 1403 keeps records of what advertisement information was distributed to which DSC 1401.

In some embodiments, DSC 1401 or a coupled Active Storage Device receives advertisement information from a remote server. In some embodiments, the information is composed of image data files containing the advertisement and ready to be presented. In some embodiments, the information requires processing prior to being presented. In some embodiments, the image data file with advertisement information is stored in the file system of a coupled memory card. In some embodiments, the image data file with advertisement information is stored in the file system of an Active Storage Device coupled to DSC 1401. In some embodiments, the image data file with advertisement information is stored in the file system of DSC 1401's embedded memory.

In some embodiments, the image data file with advertisement information is adapted for presentation without being stored in the file system. In some embodiments the image data file with advertisement information is displayed when DSC 1401 is in viewing mode. In some embodiments the image data file with advertisement information is removed from the file system after being presented. In some embodiments, the image data file with advertisement information remains in the file system.

In some embodiments, advertising information may be a synthesized image, a synthesized video, an audio element, a textual element, or any combination of the above, this invention is not so limited.

In some embodiments, the advertising information is displayed in intervals, for example when DSC 1402 is in playback mode, every fifth image presented to the user is an advertisement. In some embodiments, user may act upon advertisement information, for example by clicking on a DSC 1401 button to access more information about the advertised offering.

In some embodiments, advertising information is a layer of information to be displayed on top of images captured by DSC 1401, for example every captured image presented on DSC 1402's display in playback mode is overlaid with a sponsorship message such as “Brought to you by Coca-Cola”.

In some embodiments, advertising information sent from remote ad server 1403 may be contextual, based upon information received from ad manager 1402 and/or DSC 1401, or based on the content of captured images that were uploaded to remote ad server 1403. For example, a DSC 1401 being employed by a user in Disney World will receive advertisement information for a new Disney movie. In some embodiments, advertising information may be based on the content of at least one of the photos captured by the user of DSC 1401.

It can be appreciated by those skilled in the art, that employing the above schematics, any digital content may be transferred to DSC 1401, not just advertisements, this invention is not so limited.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

We claim:

1. A method for presenting digital content on a digital camera, comprising: transmitting digital content from a remote server to content management means coupled to a digital camera, and performing an action on said digital content.

2. The method of claim 1, wherein said content management means is an active storage device.

3. The method of claim 1, wherein said content management means is communicatively coupled to said remote server.

4. The method of claim 1, wherein said digital content is at least part of a digital image.

5. The method of claim 1, wherein said digital content is at least part of a video clip.

6. The method of claim 1, wherein said digital content is at least part of an audio clip.

7. The method of claim 1, wherein said digital content is at least text.

8. The method of claim 1, wherein said digital content is at least part of a World Wide Web page.

9. The method of claim 1, wherein said digital content is at least part of an advertisement.

10. The method of claim 1, wherein said digital content is at least part of a map.

11. The method of claim 1, wherein said digital content is at least part of an email.

12. The method of claim 1, wherein said digital content is at least part of an SMS.

13. The method of claim 1, wherein said digital content is a reproduction of an audio-video information element previously captured by said digital camera.

14. The method of claim 1, wherein said performing an action comprises at least presenting said digital content on presentation means of a digital camera coupled to said content management means.

15. The method of claim 1, wherein said performing an action comprises at least adapting said digital content for presentation on presentation means of a digital camera coupled to said content management means.

16. The method of claim 15, wherein said adapting comprises generating a synthetic image from at least a part of said digital content.

17. The method of claim 15, wherein said adapting comprises generating a synthetic video clip from at least a part of said digital content.

18. The method of claim 15, wherein said adapting comprises: combining at least part of said digital content with an audio-visual information element to create a synthetic image.

19. The method of claim 18, wherein said audio-visual information element is at least part of a photo captured by a digital camera coupled to said ad management means.

20. The method of claim 15, wherein said adapting comprises: combining at least part of said digital content with an audio-visual information element to create a synthetic video clip.

21. The method of claim 20, wherein said audio-visual information element is at least part of a video clip captured by a digital camera coupled to said ad management means.

22. The method of claim 15, wherein at least part of said digital content is overlaid on at least part of an audio-visual information element captured by a digital camera coupled to said content management means.

23. The method of claim 1, further comprising performing an action on at least an audio-video element captured by a digital camera coupled to said content management means.

24. The method of claim 1, further comprising sending contextual information from said content management means to said remote server prior to said transmitting digital content, whereby said digital content is determined by at least part of said contextual information.

25. The method of claim 24, wherein said contextual information at least relates to an attribute of a digital camera coupled to said content management means.

26. The method of claim 24, wherein said contextual information at least relates to an attribute of an end-user of a digital camera coupled to said content management means.

27. The method of claim 24, wherein said contextual information at least relates to an attribute of said content management means.

28. The method of claim 24, wherein said contextual information at least relates to an attribute of data stored in storage means of said content management means.

29. The method of claim 24, wherein said contextual information at least relates to an attribute of an audio-visual information element captured by a digital camera coupled to said content management means.

30. The method of claim 24, wherein said contextual information comprises at least part of an audio-visual information element captured by a digital camera coupled to said content management means.

31. The method of claim 24, wherein said contextual information comprises at least part of a geographic location.

32. The method of claim 31, wherein said digital content is a map related to said geographic location.

33. The method of claim 24, wherein said contextual information comprises at least part of a search query.

34. The method of claim 24, wherein said contextual information comprises at least part of a URL.

35. The method of claim 24, wherein said contextual information comprises at least a personal identifier.

36. The method of claim 24, wherein said contextual information comprises at least part of an email address.

37. The method of claim 24, wherein said contextual information comprises at least part of a phone number.

38. The method of claim 24, further comprising deriving said contextual data by said content management means from at least part of an audio-visual information element captured by a digital camera coupled to said content management means.

39. The method of claim 38, further comprising performing optical character recognition by said content management means on said audio-video information element, whereby said contextual information is derived from alphanumeric information present in said audio-visual information element.

40. The method of claim 1, further comprising receiving an end-user response to said digital content.

41. The method of claim 40, wherein said end-user response is generated by operation of said digital camera's end-user control means.

42. The method of claim 41, further comprising transmitting said end-user response to said remote server.

43. The method of claim 14, wherein said digital content is presented prior to presentation of an audio-visual information element captured by a digital camera.

44. The method of claim 14, wherein said digital content is presented subsequent to presentation of an audio-visual information element captured by a digital camera.

45. The method of claim 14, wherein said digital content is presented simultaneously with presentation of an audio-visual information element captured by a digital camera.

46. The method of claim 1, further comprising generating a reproduction of at least part of an audio-video information element captured a digital camera coupled to said content management means.

47. The method of claim 1, wherein said performing an action comprises storing at least part of said digital content by said digital content management means.

48. An active storage device adapted to be coupled to a digital camera, comprising a non-volatile storage, a controller and wireless communications means, said non-volatile storage adapted to store a content manager that is configured to perform actions, comprising: receiving digital content from a remote server, and performing an action on said digital content.

49. The active storage device of claim 48, wherein said active storage device is coupled to a digital camera.

50. The active storage device of claim 48, wherein said content manager is further configured to adapt said digital content for presentation on a coupled digital camera's presentation means.

51. The active storage device of claim 48, wherein said content manager is further configured to transfer said digital content for presentation on a coupled digital camera's presentation means.

52. The active storage device of claim 48, wherein said content manager is further configured to send contextual information to said remote server.

53. The active storage device of claim 52, wherein said contextual information at least relates to an attribute of data stored in said non-volatile storage.

54. The active storage device of claim 52, wherein said contextual information comprises at least part of an audio-visual information element captured by a digital camera coupled to said active storage device.

55. The active storage device of claim 52, further comprising a geographic module coupled to said content manager, wherein said contextual information comprises at least a geographic location calculated by said geographic module, whereby said digital content is localized to said geographic location.

56. The active storage device of claim 55, wherein said digital content is a map.

57. The active storage device of claim 48, wherein said content manager is further adapted to generate a reproduction of at least part of an audio-video information element captured by a digital camera coupled to said active storage card.

58. The active storage device of claim 57, wherein said reproduction requires less said non-volatile memory for storage than said audio-video information element.

59. The active storage device of claim 48, wherein at least part of said digital content is stored in said non-volatile storage

60. A system, comprising a content manager and a remote server communicatively coupled to each other, said content manager operationally coupled to a digital camera, wherein said remote server transmits digital content to said content manager for use with said digital camera.

61. The system of claim 60, wherein said content manager transfers said digital content for presentation to said digital camera's presentation means.

62. The system of claim 60, wherein said content manager adapts said digital content for presentation on a digital camera's presentation means.

63. The system of claim 60, wherein said content manager is at least software configured to execute on at least an active storage device.

64. The system of claim 60, wherein said content manager and said remote server are wirelessly coupled.

65. The system of claim 60, wherein said digital camera is a digital still camera.

66. The system of claim 60, wherein said digital camera is a digital video camera.

67. The system of claim 60, further comprising a digital camera.

68. The system of claim 60, wherein said remote server determines said digital content based on contextual information received from said content manager.

69. The system of claim 68, wherein said contextual information comprises at least an audio-visual information element captured by a digital camera coupled to said content manager.

70. The system of claim 68, wherein said content manager comprises a geographic module adapted to calculate geographic information, wherein said contextual information is related to said geographic information.

71. The system of claim 70, wherein said geographic module receives at least geographic data from a GPS receiver.

72. The system of claim 63, wherein said digital content is stored on a non-volatile memory of said active storage device.
